(19) United States
(12) Patent Application Publication
(10) Pub. No.: US 2026/0016627 A1
(43) Pub. Date: Jan. 15, 2026

(54) LIGHT PIPE ASSEMBLY AND A LIGHTING DEVICE HAVING A LIGHT PIPE ASSEMBLY

(71) Applicant: VALEO VISION, Bobigny (FR)

(72) Inventors: Jessica CORONADO, Queretaro City (MX); Emigdio LEON, Queretaro City (MX); Sergio TENERIA, Queretaro City (MX)

(73) Assignee: VALEO VISION, Bobigny (FR)

(21) Appl. No.: 18/769,785

(22) Filed: Jul. 11, 2024

(51) Int. Cl. F21V 8/00; F21S 41/24; F21Y 115/10

(52) U.S. Cl. CPC G02B 6/0096; F21S 41/24; F21Y 2115/10

(57) ABSTRACT

The invention relates to a light pipe assembly and a lighting and/or signaling device including the light pipe assembly. The light pipe assembly includes a first section configured to receive light from a light source, a second section extending from the first section, and a third section extending from the second section. The second section consists of a shaping optical structure that is disposed at a side opposite to the first section and integrated within the light pipe. The second section being configured to transmit the received light in a first direction towards the shaping optical structure by total internal reflection. The third section being curved is configured to receive light from the shaping optical structure, and is configured to change direction of light in a direction different from the first direction and towards a light exit surface.

### TECHNICAL FIELD

The present invention relates to the field of lighting and/or signaling devices for vehicles. In particular, the present invention relates to a lighting and/or signaling device for a motor vehicle including a light pipe assembly. The invention also concerns a light pipe assembly as such.

### BACKGROUND OF THE INVENTION

Lighting devices are an integral part of automotive vehicles. Such lighting devices may represent various types such as headlamps, tail lamps, signal lamps, and the like, which may be used for different functions of the automotive vehicle. The lighting devices typically have a lighting arrangement including multiple components such as light sources, reflectors, light guides, collimators, an outer lens, housing, heatsinks, Printed Circuit Boards (PCBs), and so on and so forth. The lighting devices of the automotive vehicles are undergoing drastic changes in terms of size reduction, type of light source, thickness of reflectors and lenses, and the like which has resulted in the multiple components of the lighting device being closely arranged and formed into a single package.

Conventionally, light guides are used to transmit light from the light source of the lighting device. They are also used to transfer light from one point to another within the automotive vehicle. However, due to space constraints it is difficult to use a bigger light guide. When the distance between two points increases, the light guide required is bigger and lengthier, and the efficiency of the light transmitted at the output decreases due to loss of light. Further, the lighting arrangement becomes bulky and costlier to design. Additionally, a high power light source with increased power consumption is required to efficiently power the light output, which increases cost of the lighting device.

### SUMMARY OF THE INVENTION

The present invention is directed to an improved light pipe assembly that addresses at least one or more of the issues described in the above paragraphs. It is believed that one potential benefit of the present invention over the prior art is that the light pipe assembly can be used to provide a homogenous light distribution in reduced space. Further, because of curved structure of the light pipe assembly, it can be flexibly arranged with other components of the automotive vehicle in a tightly packed arrangement with limited space. In addition, the light pipe assembly is designed such that it can be used in multiple automotive lighting arrangements such as exterior lighting, side marker lights, ambient lights, interior lighting, rear lighting, etc. without requiring any significant changes in the design. Moreover, the light pipe assembly can be used for transmitting light from one part of the automotive vehicle to another part, for example, the light pipe may be used to transfer light from the headlamp to a side of the vehicle to perform side marker function with reduced space constraints.

Accordingly, pursuant to one aspect of the present invention, there is contemplated a light pipe assembly that includes a first section configured to receive light from a light source, a second section extending from the first section, wherein the second section having a shaping optical structure is disposed at a side opposite to the first section and integrated within the light pipe, the second section being configured to transmit the received light in a first direction towards the shaping optical structure by total internal reflection; and a third section being curved is extending from the second section and being configured to receive light from the shaping optical structure, the third section having a light incident surface and a light exit surface, wherein the light incident surface is configured to change direction of light in a direction different from the first direction and towards the light exit surface.

The invention may be further characterized by one or any combination of features described herein, such as the light incident surface includes a plurality of optical structures arranged symmetrically on curvature of the third section to direct the incident light from the shaping optical structure towards the light exit surface.

In a non-limiting embodiment of the present invention, the plurality of optical structures is one or more of a prism, a reflector, a refractor and a lens.

In a non-limiting embodiment of the present invention, the shaping optical structure is one or more of a collimator, and a lens.

In a non-limiting embodiment of the present invention, the shaping optical structure is configured to focus the light from the first section towards the light incident surface of the third section.

In a non-limiting embodiment of the present invention, the light exit surface is formed by an arrangement of a plurality of light exit optical structures.

In a non-limiting embodiment of the present invention, the plurality of light exit optical structures is one or more of a pillow, a lens, a diffracting structure, and a decorative element.

In a non-limiting embodiment of the present invention, the plurality of light exit optical structures of the light exit surface is configured to disperse the light from the second section in multiple directions.

In a non-limiting embodiment of the present invention, the light pipe assembly is manufactured as a single component via injection molding.

In a non-limiting embodiment of the present invention, the light incident surface and the light exit surface are substantially perpendicular to one another.

In a non-limiting embodiment of the present invention, the second section is flexible and is configured to position the light pipe assembly within a vehicle.

In a non-limiting embodiment of the present invention, the first section is configured to be mounted on a Printed Circuit Board (PCB) having the light source.

Accordingly, pursuant to another aspect of the present invention, there is contemplated a lighting and/or signaling device for an automotive vehicle, the lighting and/or signaling device including a light source; a housing, the housing including an opening; a light pipe assembly connected to the lighting and/or signaling device via the opening, the light pipe assembly further including a first section configured to receive light from the light source, a second section extending from the first section, wherein the second section having a shaping optical structure is disposed at a side opposite to the first section and integrated within the light pipe, the second section being configured to transmit the received light in a first direction towards the shaping optical structure by total internal reflection; and a third section being curved is extending from the second section and being configured to receive light from the shaping optical structure, the third section having a light incident surface and a light exit surface, wherein the light incident surface is configured to change direction of light in a direction different from the first direction and towards the light exit surface.

### BRIEF DESCRIPTION OF DRAWINGS

To further provide a more encompassing description and a better understanding of the invention, a set of drawings is provided. Said drawings form an integral part of the description and illustrate embodiment aspects of the invention, which should not be construed as restricting the scope of the invention, but only as examples of how the invention can be carried out. The foregoing and other features, and advantages of the invention are apparent from the following detailed description taken in conjunction with the accompanying drawings in which:

FIG. 1 is a longitudinal section view of the light pipe assembly, according to an embodiment of the present invention;

FIG. 2 is a section perspective and detail view of an end of the light pipe assembly, according to an embodiment of the present invention;

FIG. 3 is a section perspective and detail view of light incident surface at the third section of the light pipe assembly, according to an embodiment of the present invention;

FIG. 4 shows path of light rays in the light pipe assembly, according to an embodiment of the present invention;

FIG. 5a shows path of direct light ray in the third section of the light pipe assembly, according to an embodiment of the present invention;

FIG. 5b shows path of internally reflected light ray in the third section of the light pipe assembly, according to an embodiment of the present invention;

FIG. 6a shows an automotive vehicle having the light pipe assembly at front of the vehicle, according to an embodiment of the present invention;

FIG. 6b shows an automotive vehicle having the light pipe assembly at rear of the vehicle, according to an embodiment of the present invention; and

FIG. 6c shows an automotive vehicle having the light pipe assembly at interior of the vehicle, according to an embodiment of the present invention.

### DETAILED DESCRIPTION OF THE INVENTION

Hereinafter, embodiments of the present invention will be described with reference to the accompanying drawings.

Referring now to the Figures, where the invention will be described with reference to specific embodiments, without limiting same, a light pipe assembly in accordance with the invention is explained with the use of drawings. The light pipe assembly may be employed in any suitable application or design, including as a light guide for various vehicles or in various vehicular applications, particularly in all manner of automotive vehicles. In one embodiment, the light pipe assembly can be configured as a vehicular exterior lighting device or a vehicular interior lighting device. In one embodiment, the vehicular exterior lighting device can include a side marker light, a tail light, a parking light, a daytime running light, position light, a head light, or the like. In another embodiment, the vehicular interior lighting device can include door lights, ambient lights, dashboard lights, cockpit lights, or the like.

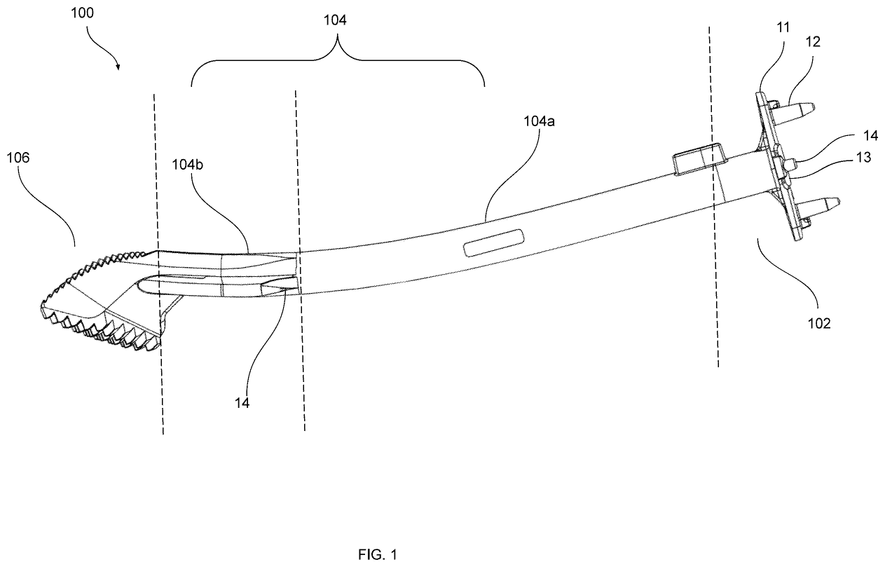

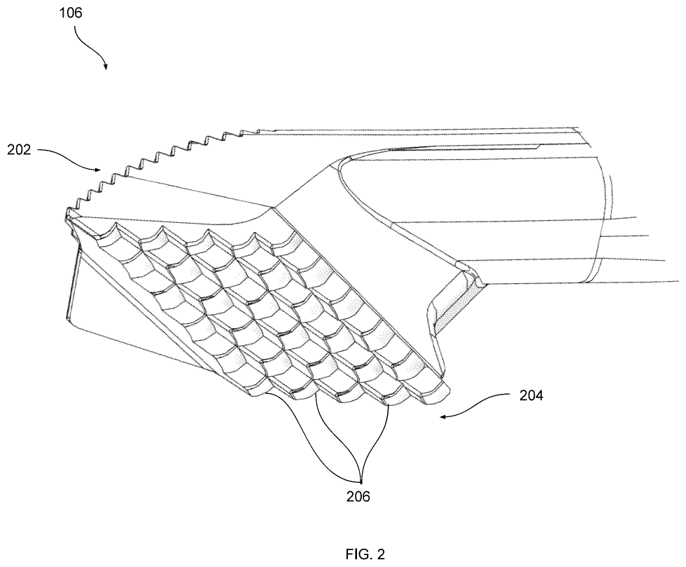

FIG. 1. shows a longitudinal section view of a light pipe assembly 100, according to an embodiment of the present invention. The light pipe assembly 100 can include a first section 102 configured to receive light from a light source (not shown in figure). The light source may be a solid-state device such as a Light Emitting Diode (LED). The light source can be mounted on a holder 13 disposed on a base plate 11 of the light pipe assembly 100. The base plate 11 may accommodate a Printed circuit board (not shown in figure) on which the light source can be mounted. The light pipe assembly 100 can also include a plurality of ribs 12 extending away from the base plate 11. The plurality of ribs 12 can be used for securing the light pipe 100 within the wider automotive lighting arrangement. In an embodiment, the first section 102 is also known as input face of the light pipe assembly 100, and can include a collimator 14. In another embodiment, the first section 102 can be a planar structure that is flat, and without the collimator 14. The flat planar structure can be adapted to receive light from the light source. In another embodiment, the collimator 14 is configured to receive light from the light source and collimate the light rays. The light pipe assembly 100 can include a second section 104 extending longitudinally from the first section 102. The second section 104 includes an internal reflection section 104a and a focusing section 104b. In an embodiment, the second section 104 may be cylindrical in shape. The focusing section 104b can include a shaping optical structure 14 that is disposed at a side opposite to the first section 102, and integrated within the light pipe 100. The internal reflection section 104a of the second section 104 is configured to transmit light from the light source in a first direction towards the shaping optical structure 14 by total internal reflection. The shaping optical structure 14 enables focusing of the light from the internal reflection section 104a such that the intensity of the reflected light is increased. The shaping optical structure 14 ensures that the intensity of the reflected light can be maintained even when length of the internal reflection section 104a is substantially increased. The light pipe assembly 100 further includes a third section 106 extending from the second section 104. In an embodiment, the first section 102, the second section 104, and the third section 106 of the light pipe assembly 100 can be manufactured as a single component via injection molding. As can be seen from the FIG. 1, the third section 106 is curved and includes a light incident surface and a light exit surface. The third section 106 is configured to receive light from the shaping optical structure 14 of the second portion 104. The third portion 106 is disposed at the end of the light pipe assembly 100 and is configured to disperse light at the output. The third section 106 disperses the received light from the light source such that the direction of the emitted light is different from the direction of the light received from the light source 100. The third section 106 is explained in more detail with respect to FIG. 2.

FIG. 2 is a section perspective and detail view of an end of the light pipe assembly 100, according to an embodiment of the present invention. The end of the light pipe assembly 100 includes the third section 106 as can be seen from the FIG. 2. The third section 106 can include a light incident surface 202 and a light exit surface 204 disposed therein. The light incident surface 202 is located at the curvature of the third section 106 whereas the light exit surface 204 is at the extremity of the light pipe assembly 100. The light incident surface 202 is configured to receive light in a first direction from the second section 104 of the light pipe assembly 100. Subsequently, the light incident surface 202 is configured to change direction of light in a direction different from the first direction and towards the light exit surface 204. In an embodiment, the light incident surface 202 and the light exit surface 204 are substantially perpendicular to one another. The light exit surface 204 can be formed by an arrangement of a plurality of light exit optical structures 206. In an embodiment, the plurality of light exit optical structures 206 can be one or more of a pillow, a lens, a diffracting structure, and a decorative element. The plurality of light exit optical structures 206 of the light exit surface 204 is configured to disperse the light in different directions.

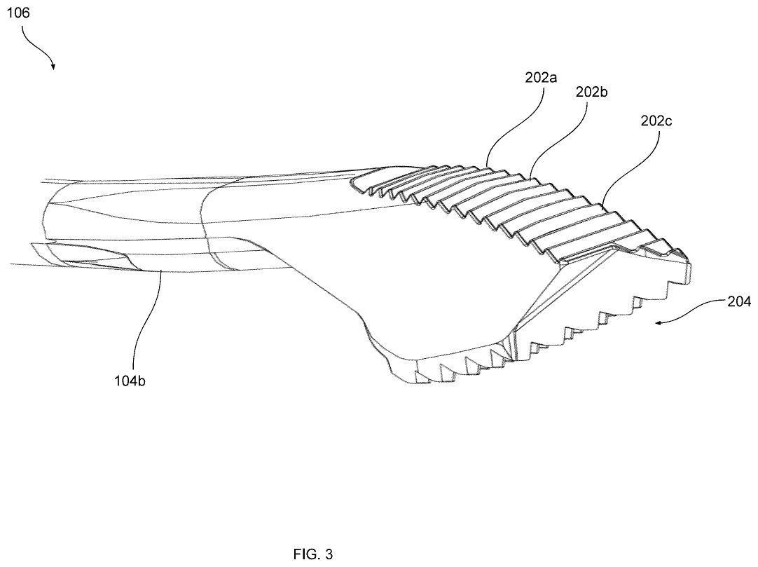

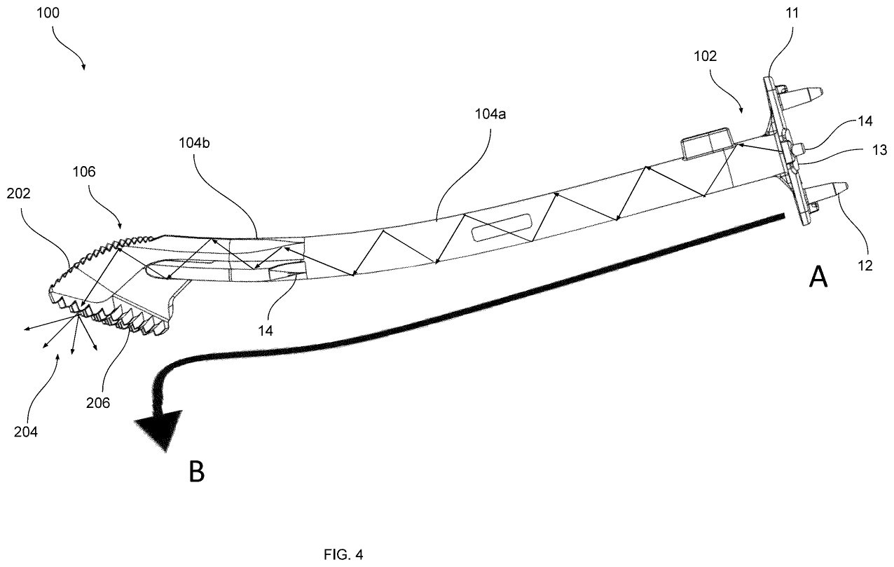

FIG. 3 is a section perspective and detail view of the light incident surface 202 at the third section 106 of the light pipe assembly 100, according to an embodiment of the present invention. The light incident surface 202 is disposed on the curvature of the light pipe assembly 100. As can be seen from the FIG. 3, the light incident surface 202 includes a plurality of optical structures 202a, 202b, 202c arranged symmetrically at the curvature. The symmetrical arrangement of the plurality of optical structure 202a, 202b, 202c ensures that the incident light received from the shaping optical structure 14 is directed towards the light exit surface 204. Further, the symmetrical arrangement of the optical structures 202a, 202b, 202c is configured to change direction of incident light received from the shaping optical structure 14. In an embodiment, the plurality of optical structures 202a, 202b, 202c can include one or more of a prism, a reflector, a refractor, and a lens. In an embodiment, the plurality of optical structures 202a, 202b, 202c disposed on the curvature may have a parabolic or elliptical profile extending from the focusing section 104b of the light pipe assembly 100. The working of the light pipe assembly 100 is explained with reference to FIG. 4.

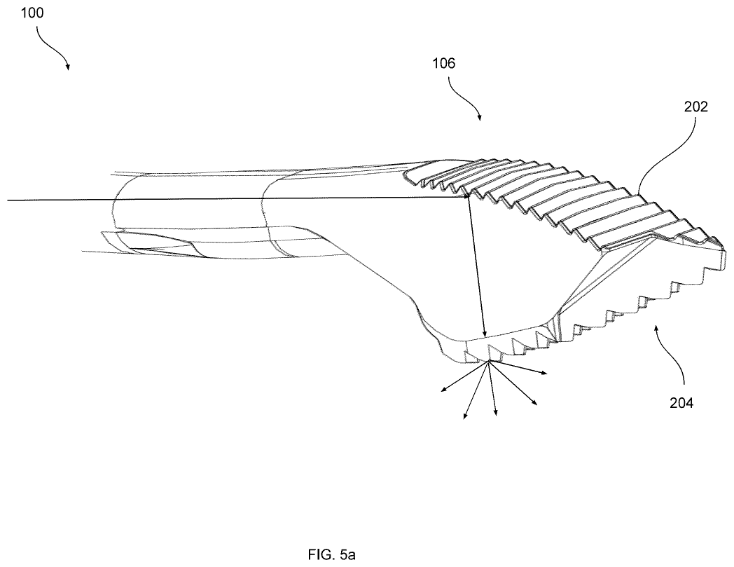

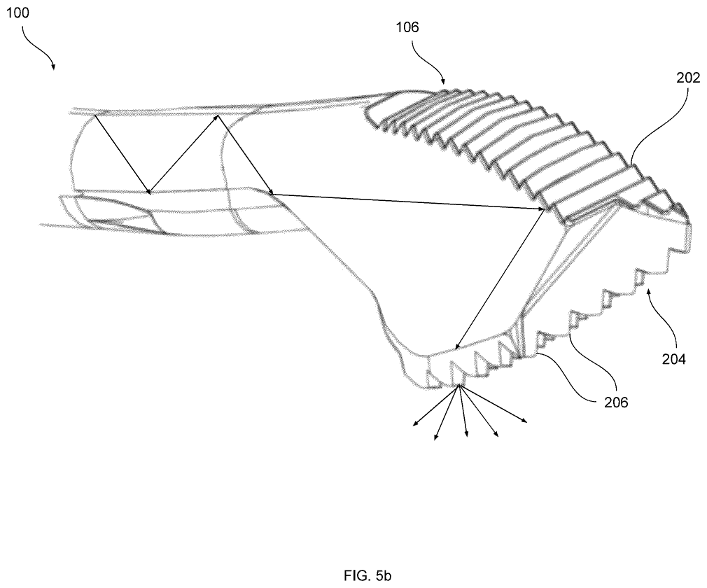

FIG. 4 shows path of light rays in the light pipe assembly 100, according to an embodiment of the present invention. The light pipe assembly 100 can include the light source that is mounted on the holder 13. The light source may emit light that can be passed through the collimator 14 of the light pipe assembly 100. The light emitted by the light source can be transmitted from point A to point B via the light pipe assembly 100 as shown in FIG. 4. In an embodiment, the point A and point B can be different locations within the automotive vehicle. For example, the point A can be any location inside the headlamp wherein the light pipe assembly 100 can be attached whereas the point B can be the location reserved for a side marker or an indication function located below or on a side of the headlight in the automotive vehicle. The light pipe assembly 100 can be attached within the automotive vehicle by the plurality of ribs 12. The light rays emitted by the light source may be collimated by the collimator 14 and directed towards the first section 102 of the light pipe assembly 100. Subsequently, the light rays may pass through the internal reflection section 104a and reach the focusing section 104b by total internal reflection. Thereafter, the shaping optical structure 14 of the focusing section 104b may increase the intensity of the received light and may transmit the received light towards the third section 106. The first section 102 and second section 104 may transmit the light ray in a first direction from point A to point B as shown in FIG. 4. The light ray may hit the light incident surface 202 of the third section 106. Due to the symmetrical arrangement of the plurality of optical structures 202a, 202b, 202c disposed at the curvature of the third section 106, the direction of the light ray is changed in a direction different from the first direction that is received from the first section 102 and second section 104 respectively. In an example embodiment, the plurality of optical structures 202 may be Fresnel lenses or prisms disposed at the curvature. In another example embodiment, the curvature may be parabolic or elliptical in shape. The light incident surface 202 of the third section 106 may change the direction of the light rays towards the light exit surface 204. As can be seen from the FIG. 4, the light rays entering the light pipe assembly 100 at point A travels through the first and section sections 102, 104 in the same direction and changes the direction at the light exit 204 located at point B. In an example embodiment, the third section 106 changes direction of the light rays in a direction perpendicular to the first direction and towards the light exit surface 204. In an example embodiment, the light exit surface 204 can consist of a plurality of light exit optical structures 206 such as pillows or diffracting structures that are configured to disperse light on all directions. The light rays may exit the light pipe assembly 100 via the light exit surface 204. In some example embodiments, the light ray travelling from the first section 102 towards the third section 106 can be a direct light ray that travels through the light pipe assembly without being reflected by the first section 102 or the second section 104. The working of the light pipe 100 in this scenario is explained with reference to FIG. 5a.

FIG. 5a shows path of direct light ray in the third section 106 of the light pipe assembly 100, according to an embodiment of the present invention. In an embodiment, there can be some light rays that may not undergo total internal reflection in the first section 102 and the second section 104 and may directly enter the third section 106. Such light rays could directly hit the light incident surface 202 of the third section 106. The plurality of optical structures 202 disposed symmetrically at the curvature enables the light pipe assembly 100 to change the direction of the light rays in a direction perpendicular to the direction of the incident light. In an embodiment, the curvature may be parabolic or elliptical shape. In an embodiment, the direction of the light ray is changed in a direction that is different from the incident light and not necessarily in perpendicular direction. In an embodiment, this change of direction of the light ray may be due to the plurality of optical structures 202 being prisms disposed symmetrically in parabolic curvature at the third section 106. The parabolic shape of the curvature ensures that direction of the direct incident light entering the third section 106 is changed and directed towards the light exit surface 204. In an embodiment, the light incident surface 202 and the light exit surface 204 are substantially perpendicular to one another. In an embodiment, the light exit surface 204 having light exit optical structures such as pillows 206 can disperse the light at the exit in all directions as shown in the FIG. 5a. In some embodiments, the light rays entering the third section 106 may not be a direct ray and can be a ray that undergoes reflection and hits the third section 106 in different directions. The working of the light pipe 100 in this scenario is explained with reference to FIG. 5b.

FIG. 5b shows path of internally reflected light ray in the third section 106 of the light pipe assembly 100, according to an embodiment of the present invention. The light ray entering the light pipe assembly 100 may undergo total internal reflection and therefore hit the light incident surface 202 of the third section 106 from different incident angles and directions that may not necessarily be a straight line. Although the incident light is not a direct light or in a straight line, the plurality of optical structures 202 symmetrically arranged at the curvature of the third section 106 ensures that the direction of the incident light is changed and directed towards the light exit surface 204. In an embodiment, the curvature can be parabolic or elliptical in shape and can ensure that the entirety of the light rays entering the third section 106 from different directions and angle of incidence are directed towards the light exit surface 204. In an embodiment, the light exit surface 206 having pillows can disperse the light at the exit in all directions as shown in the FIG. 5b. Thus, the light pipe assembly 100 provides better homogeneity of light distribution.

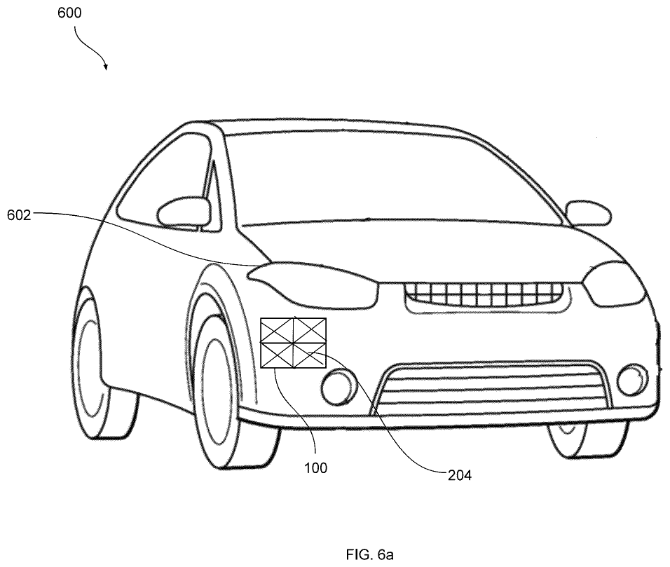

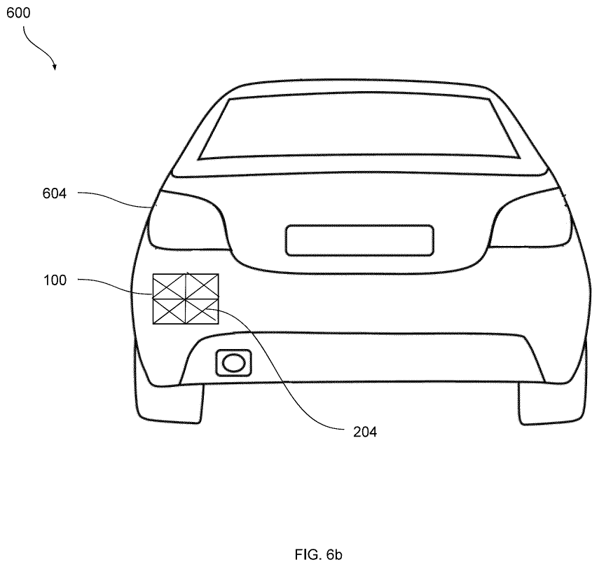

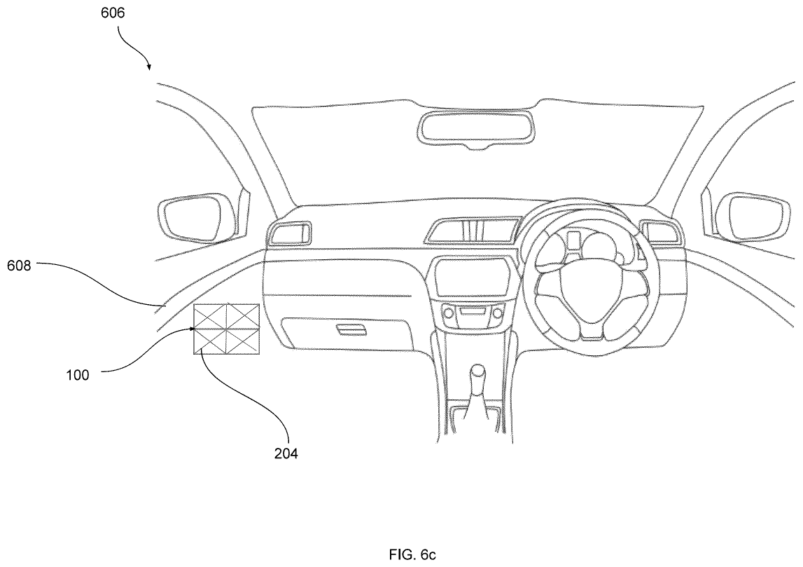

FIG. 6a shows an automotive vehicle 600 having the light pipe assembly 100 at front of the vehicle, according to an embodiment of the present invention. The automotive vehicle 600 can have a lighting and/or signaling device 602 such as for example a headlamp to illuminate road ahead. In an embodiment, the lighting and/or signaling device 602 can include a light source (not shown), a housing (not shown) wherein the housing includes an opening (not shown), a light pipe assembly 100 connected to the lighting and/or signaling device 602 via the opening, the light pipe assembly 100 further consisting a first section (not shown) configured to receive light from the light source, a second section (not shown) extending from the first section. The second section having a shaping optical structure (not shown) is disposed at a side opposite to the first section and integrated within the light pipe 100, the second section being configured to transmit the received light in a first direction towards the shaping optical structure by total internal reflection. The light pipe assembly 100 further includes a third section (not shown) being curved is extending from the second section and being configured to receive light from the shaping optical structure. The third section having a curved light incident surface (not shown) and a light exit surface 204 such that the light incident surface is configured to change direction of light in a direction different from the first direction and towards the light exit surface 204.

In an example embodiment, the light pipe assembly 100 can be used to perform a side marker function for the automotive vehicle 600. In another embodiment, the first portion 102 (not shown in figure) can be attached inside the headlamp 602, and the light exit surface 204 of the light pipe assembly 100 can be located at the exterior of the automotive vehicle 600 near to the headlight 602. Therefore, the user may only view the light exit surface 204 of the light pipe assembly 100. In an embodiment, the first portion 102 (not shown in figure) of the light pipe assembly 100 can be attached to any portion/component located inside the automotive vehicle 600 whereas the light exit surface 204 can be positioned at an exterior location preferably at front of the vehicle 600. In an embodiment, the second section 104 (not shown) of the light guide 100 can be rigid, and the curvature of the third section 106 can enable positioning of the light pipe assembly 100 as per the front lighting requirements of the automotive vehicle 600. In another embodiment, the second section 104 (not shown) can be semi-flexible, and can enable to position the light pipe assembly 100 as per the requirements of the automotive vehicle 600.

FIG. 6b shows an automotive vehicle 600 having the light pipe assembly 100 at rear of the vehicle, according to an embodiment of the present invention. The rear of the vehicle can include a rear lamp 604 that performs rear lighting functions such as stop light, break light, turn indication or the like. The light pipe assembly 100 can be integrated at the rear of the automotive vehicle 600 to perform various functions. In an example embodiment, the light pipe assembly 100 can be located at the rear end of the automotive vehicle 600. In some example embodiments, the first section 102 (not shown) of the light pipe assembly 100 can be attached with the rear lamp 604, and the light exit surface 204 of the light pipe assembly 100 can be located at the exterior of the automotive vehicle 600 near to the rear lamp 604. In an embodiment, the first portion 102 (not shown in figure) of the light pipe assembly 100 can be attached to any portion/component located inside the automotive vehicle 602, whereas the light exit surface 204 can be positioned at an exterior location preferably at the rear of the vehicle 600. In an embodiment, the second section 104 (not shown) of the light guide 100 can be rigid, and the curvature of the third section 106 can enable positioning of the light pipe assembly 100 as per the rear lighting requirements of the automotive vehicle 600. In another embodiment, the second section 104 (not shown) can be semi-flexible, and can enable to position the light pipe assembly 100 as per the design requirements at the rear of the automotive vehicle 600.

FIG. 6c shows an automotive vehicle 600 having the light pipe assembly 100 at interior 606 of the vehicle, according to an embodiment of the present invention. The interior 606 of the vehicle 600 can perform interior lighting functions such as ambient lighting, door opening lights, cockpit lights or the like. In an example embodiment, the light pipe assembly 100 can be integrated on a door 608 of the automotive vehicle 600 as seen in FIG. 6c. The first portion 102 (not shown) of the light pipe assembly 100 can be attached inside the automotive vehicle 600, and the light exit surface 204 of the light pipe assembly 100 can be located at the door 608 of the automotive vehicle 600. In an embodiment, the second section 104 (not shown) of the light guide 100 can be rigid, and the curvature of the third section 106 can enable positioning of the light pipe assembly 100 as per the interior lighting requirements of the automotive vehicle 600. In another embodiment, the second section 104 (not shown) can be semi-flexible and can enable to position the light pipe assembly 100 as per the interior lighting requirements of the automotive vehicle 600.

Although the present disclosure provides references to figures, all embodiments shown in the figures are intended to explain preferred embodiments of the present invention by way of example rather than being intended to limit the present invention. Preferred embodiments of the present invention have been disclosed. However, it should be apparent to a person of ordinary skill in the art that certain modifications would come within the teachings of this invention and that various changes or modifications can be made in the present disclosure without departing from the principles and spirit of the disclosure, which are intended to be covered by the present invention as long as these changes or modifications fall within the scope defined in the claims and their equivalents.

### LIST OF ELEMENT NUMBERS

Light Pipe Assembly 100
First Section 102
Second Section 104
Third Section 106
Base Plate 11
Plurality of Ribs 12
Holder 13
Shaping Optical Structure 14
Internal Reflection Section 104a
Focusing Section 104b
Light Incident Surface 202
Plurality of Optical Structures 202a, 202b, 202c
Light Exit Surface 204
Plurality of Light Exit Optical Structures 206
Automotive Vehicle 600
Lighting and/or Signaling Device 602
Rear Lamp 604
Interior of Vehicle 606
Door of Vehicle 608

1. A light pipe assembly comprising:
a first section configured to receive light from a light source;
a second section extending from the first section, wherein the second section having a shaping optical structure is disposed at a side opposite to the first section and integrated within the light pipe, the second section being configured to transmit the received light in a first direction towards the shaping optical structure by total internal reflection; and
a third section being curved is extending from the second section and being configured to receive light from the shaping optical structure, the third section having a light incident surface and a light exit surface, wherein the light incident surface is configured to change direction of light in a direction different from the first direction and towards the light exit surface.

2. The light pipe assembly of claim 1, wherein the light incident surface comprises a plurality of optical structures arranged symmetrically on curvature of the third section to direct the incident light from the shaping optical structure towards the light exit surface.

3. The light pipe assembly of claim 2, wherein the plurality of optical structures is one or more of a prism, a reflector, a refractor and a lens.

4. The light pipe assembly of claim 1, wherein the shaping optical structure is one or more of a collimator, and a lens.

5. The light pipe assembly of claim 1, wherein the shaping optical structure is configured to focus the light from the first section towards the light incident surface of the third section.

6. The light pipe assembly of claim 1, wherein the light exit surface is formed by an arrangement of a plurality of light exit optical structures.

7. The light pipe assembly of claim 6, wherein the plurality of light exit optical structures is one or more of a pillow, a lens, a diffracting structure, and a decorative element.

8. The light pipe assembly of claim 1, wherein the plurality of light exit optical structures of the light exit surface is configured to disperse the light from the second section in multiple directions.

9. The light pipe assembly of claim 1, wherein the light pipe assembly is manufactured as a single component via injection molding.

10. The light pipe assembly of claim 1, wherein the light incident surface and the light exit surface are substantially perpendicular to one another.

11. The light pipe assembly of claim 1, wherein the second section is flexible and is configured to position the light pipe assembly within a vehicle.

12. The light pipe assembly of claim 1, wherein the first section is configured to be mounted on a Printed Circuit Board (PCB) having the light source.

13. A lighting and/or signaling device for an automotive vehicle, comprising:
a light source;
a housing, the housing comprising an opening;
a light pipe assembly connected to the lighting and/or signaling device via the opening, the light pipe assembly further comprising:
a first section configured to receive light from the light source;
a second section extending from the first section, wherein the second section having a shaping optical structure is disposed at a side opposite to the first section and integrated within the light pipe, the second section being configured to transmit the received light in a first direction towards the shaping optical structure by total internal reflection; and
a third section being curved is extending from the second section and being configured to receive light from the shaping optical structure, the third section having a light incident surface and a light exit surface, wherein the light incident surface is configured to change direction of light in a direction different from the first direction and towards the light exit surface.
